(19) United States
(12) Patent Application Publication
(10) Pub. No.: US 2026/0298275 A1
(43) Pub. Date: Oct. 1, 2026

(54) FASTENING STRUCTURE

(71) Applicant: FIVETECH TECHNOLOGY INC., New Taipei City (TW)

(72) Inventor: TING-JUI WANG, New Taipei City (TW)

(73) Assignee: FIVETECH TECHNOLOGY INC., New Taipei City (TW)

(21) Appl. No.: 19/450,782

(22) Filed: Jan. 16, 2026

(30) Foreign Application Priority Data
Mar. 28, 2025 (TW) 114112081

(51) Int. Cl. F16B 21/02; F16B 5/06

(52) U.S. Cl. CPC F16B 21/02; F16B 5/0642; F16B 2005/0671

(57) ABSTRACT

The present disclosure introduces a fastening structure, including a fastening body provided with a first fastening part and a second fastening part. The first fastening part and the second fastening part pass through a passing part of an object and an entering part of a fastened body to rotate the fastening body, allowing the first fastening part to fasten into a fastened part. Thus, quick combination and separation of at least two objects can be completed by means of cooperation of the first fastening part and the second fastening part of the fastening body, thereby achieving effects of repeated quick combination and separation.

### CROSS-REFERENCE TO RELATED APPLICATION

This non-provisional application claims priority under 35 U.S.C. § 119(a) on Patent Application No(s). 114112081 filed in Taiwan, R.O.C. on Mar. 28, 2025, the entire contents of which are hereby incorporated by reference.

### BACKGROUND OF THE INVENTION

### 1. Field of the Invention

The present disclosure relates to a fastening structure, and in particular, to a fastening structure for fastening at least two objects to achieve quick combination and easy removal.

### 2. Description of the Related Art

Generally, when two objects are combined, the two objects are usually fixed in a manner of being not easily separated from each other by means of locking in screws, so as to ensure that the two objects are stably combined, and are not easily separated from each other.

However, in terms of the foregoing fixing manner, although the two objects may be fixed and combined in a manner of being not easily separated from each other, in addition to causing difficulties in assembling the two objects, difficulties in disassembling the two objects may occur due to a fixing and combining manner of the screws.

In view of the foregoing conventional technology, the inventor develops a fastening structure, which has effects of simple structure and easiness in use, thereby effectively improving conventional absence.

### BRIEF SUMMARY OF THE INVENTION

According to a fastening structure of the present disclosure, quick combination and separation of at least two objects can be completed by means of cooperation of a first fastening part and a second fastening part of a fastening body, thereby achieving effects of repeated quick combination and separation.

To achieve the foregoing objective and other objectives, the present disclosure provides a fastening structure. The fastening structure includes a fastening body, including a first fastening part and a second fastening part, the first fastening part being configured to rotate after penetrating through or passing through an entering part of a fastened body, allowing the second fastening part to fasten to a fastened part of the fastened body.

The present disclosure provides another fastening structure. The fastening structure includes a fastening body, including a first fastening part and a second fastening part. The first fastening part and the second fastening part pass through a passing part of an object and an entering part of a fastened body to rotate the fastening body, allowing the first fastening part to fasten into or fasten to a fastened part of the fastened body.

The present disclosure provides another fastening structure. The fastening structure includes a fastening body, including a first fastening part and a second fastening part, configured to allow the fastening body to fasten into or fasten to a fastened part of a fastened body.

The present disclosure provides a method for assembling another fastening structure. The first fastening part is configured to rotate after penetrating through or passing through an entering part of the fastened body, allowing the second fastening part to fasten to the fastened part.

The present disclosure provides a method for assembling another fastening structure. The second fastening part and the first fastening part pass through a passing part of an object and an entering part of a fastened body to rotate the fastening body, allowing the first fastening part to fasten into a fastened part of the fastened body.

The present disclosure provides a method for assembling another fastening structure, which provides a fastening structure. The fastening structure includes a fastening body, and the fastening body includes a first fastening part and a second fastening part, where the first fastening part is configured to rotate after penetrating through or passing through an entering part of a fastened body to allow the second fastening part to fasten to the fastened part, or the first fastening part is smaller than the second fastening part, the fastened part is larger than the first fastening part and smaller than the second fastening part, and the entering part is larger than the second fastening part, or the second fastening part fastens, elastically fastens, rebounds to fasten or automatically and elastically retracts to fasten to the fastened part, where the first fastening part enters the fastened part to prevent rotation with the fastened part.

The present disclosure provides a method for assembling another fastening structure, which provides a fastening structure. The fastening structure includes a fastening body. The fastening body includes a first fastening part and a second fastening part. The second fastening part and the first fastening part pass through a passing part of an object and an entering part of a fastened body to rotate the fastened body to allow the first fastening part to fasten into a fastened part of the fastened body, or the first fastening part is smaller than the second fastening part, the fastened part is larger than the first fastening part and smaller than the second fastening part, and the entering part is larger than the second fastening part, or the second fastening part fastens, elastically fastens, rebound to fasten, or automatically and elastically retracts to fasten to the fastened part, or the first fastening part enters the fastened part and is configured to prevent rotation with the fastened part.

The present disclosure provides a method for assembling another fastening structure, which provides a fastening structure. The fastening structure includes a fastening body, the fastening body includes a first fastening part and a second fastening part, or is provided with an elastic component for pressing against an object, and the second fastening part and the first fastening part pass through a passing part of an object and an entering part of a fastened body to rotate the fastening structure to allow, when the first fastening part reaches a fastened part of the fastened body, the first fastening part to automatically and elastically fasten, elastically fasten into, or rebound to fasten into the fastened part, or automatically and elastically retract to fasten to the fastened part.

The present disclosure provides a method for assembling another fastening structure, which provides a fastening structure. The fastening structure includes a fastening body, the fastening body includes a first fastening part and a second fastening part, or is provided with an elastic component for pressing against an object, the second fastening part and the first fastening part pass through a passing part of the object and an entering part of a fastened body to rotate the fastening structure to allow, when the second fastening part reaches a fastened part of the fastened body, the second fastening part to automatically and elastically fasten, elastically fasten into, or rebound to fasten into the fastened part, or the first fastening part to automatically and elastically retracts to fasten, elastically fasten into, or rebound to fasten into the fastened part, or the first fastening part is smaller than the second fastening part, the fastened part is larger than the first fastening part and smaller than the second fastening part, and the entering part is larger than the second fastened part, or the first fastening part enters the fastened part and is configured to prevent rotation with the fastened part.

Optionally, the fastening structure further includes a body part, the fastening body is movably disposed on the body part, or the body part is provided with an elastic component, and two ends of the elastic component respectively press against the fastening body and the body part, or the second fastening part elastically fastens, elastically fastens into, or rebounds to fasten into the fastened part of the fastened body by means of an elastic force of the elastic component, or the first fastening part elastically and automatically retracts into the fastened part to prevent rotation with the fastened part.

Optionally, the fastening structure further includes a body part, the fastening body is movably disposed on the body part, the body part is provided with a limiting part and a rotation space, the fastening body further includes a head part, the head part is provided with an alignment part, the alignment part is limited in the limiting part to move or is configured to allow the first fastening part to enter the entering part of the fastened body and allow the alignment part to rotate in the rotation space to allow the second fastening part to fasten to the fastened part; or the rotation space is a 360-degree full-perimeter structure, or the rotation space is a non-360-degree non-full-perimeter structure, or the rotation space is a full-perimeter structure of 30 degrees to 180 degrees, or the rotation space is a non-full-perimeter structure of 30 degrees to 270 degrees.

Optionally, the body part is provided with a connecting part, the connecting part is provided with an anti-rotation part, the anti-rotation part is configured to prevent rotation with the object, limit a position, or limit a direction, or the anti-rotation part limits a direction of the first fastening part or the second fastening part, or the anti-rotation part corresponds to the limiting part and the alignment part to limit the direction of the first fastening part or the second fastening part.

Optionally, the rotation space is a 360-degree full-perimeter structure, or the rotation space is a non-360-degree non-full-perimeter structure.

Optionally, the fastening structure further includes a body part, and the fastening body is movably disposed on the body part, or the connecting part is provided with an anti-rotation part, or the anti-rotation part is configured to prevent rotation with an object, limit a position, or limit a direction, or the anti-rotation part limits a direction of the first fastening part or the second fastening part, or the anti-rotation part corresponds to the limiting part or an alignment part of the fastening body to limit a direction of the first fastening part or the second fastening part.

Optionally, the limiting part, the rotation space, or the alignment part is a convex body, a concave body, a planar body, a cambered body, a curved body, a barrier body, a hole body, a ring body, or a cross-sectional body.

Optionally, the fastening structure further includes a body part, the fastening body is movably disposed on the body part, the body part is provided with an elastic component, and two ends of the elastic component respectively press against the fastening body and the body part.

Optionally, the second fastening part elastically fastens, elastically fastens into, or rebounds to fasten into the fastened part of the fastened body by means of an elastic force of the elastic component.

Optionally, the fastening structure further includes a body part, the fastening body is movably disposed on the body part, the body part is provided with a connecting part, the connecting part is configured to rivet, fasten, expand, weld, or lock to an object, or the connecting part is integrally formed to the object.

Optionally, the fastening body is rotated to allow the fastening body to fasten to the fastened body, the fastening body has a head part, the head part is combined with the fastening body by using a combination part, or the head part and the fastening body are integrally formed, or the fastening body has a head part, the head part is rotated to allow the second fastening part to fasten to the fastened part, or the first fastening part enters the fastened part to prevent rotation with the fastened part.

Optionally, the fastening body is provided with a head part and a body part, the fastening body is movably disposed on the body part, the head part is first rotated to allow the second fastening part to be located at a fastening position corresponding to the fastened part, and then the head part is flipped or pulled to change a position of the head part on the body part to allow the second fastening part to fasten to the fastened part, or the first fastening part enters the fastened part to prevent rotation with the fastened part.

Optionally, the fastening body is disposed on or connected to an object, or the object is a radiator, or a heating body is disposed between the object and the fastened body, or the fastening body cooperates with an elastic component to apply a pressing force to the heat dissipation body, or the heat dissipation body is configured to fit the heating body to dissipate heat, where the heating body is an Integrated Circuit (IC), a Central Processing Unit (CPU), a Graphic Processing Unit (GPU), a memory, a chip, or a battery, or the fastened body is a circuit board, a metal body, a plastic body, a fastening piece, or a fastening piece connected to another object, or the heating body is connected to the fastened body by means of welding, fastening, or using a connector, where the fastened body is an ironed part, a plastic part, a Printed Circuit Board (PCB), a radiator, an IC, a memory, a water-cooled component, a handle, a fan, a power supply, a fastener, a fastening piece, a connector, a case, a cabinet, a computer, an aircraft, a vehicle component, a robot, or a data center.

Optionally, the fastening body is provided with a head part, and the head part is rotated to allow the second fastening part to fasten to the fastened part.

Optionally, the fastening body is provided with a head part and a body part, the fastening body is movably disposed on the body part, the head part is first rotated to allow the second fastening part to be located at a fastening position corresponding to the fastened part, and then the head part is flipped or pulled to change a position of the head part on the body part to allow the second fastening part to fasten to the fastened part.

Optionally, an object is included, the object is a heat dissipation body, a heating body is disposed between the object and the fastening body, and the fastening body cooperates with an elastic component to apply a pressing force to the heat dissipation body to allow the heat dissipation body to fit the heating body to radiate heat.

Optionally, the heating body is an IC, a CPU, a GPU, a memory, a chip, or a battery, or the fastening body is a circuit board, a metal body, or a plastic body, or the heating body is connected to the fastened body by means of welding, fastening, or using a connector.

Optionally, the fastening structure further includes a body part, the fastening body is movably disposed on the body part, the fastening body is provided with an alignment part, or the body part is provided with a limiting part and a rotation space, or the rotation space has a height stroke for activities and movement of the alignment part, or the limiting part has a height stroke for activities and movement of the alignment part, or a stroke of the second fastening part fastened to the fastened part is equal to or less than a height stroke of the rotation space, or a maximum stroke of the first fastening part penetrating through or passing through the fastened body is equal to or less than a height stroke of the limiting part and the height stroke of the rotation space.

Optionally, the fastened body is an ironed part, a plastic part, a PCB, a heat dissipater, an IC, a memory, a water-cooled component, a handle, a fan, a power supply, a fastener, a fastening piece, a connector, a case, a cabinet, a computer, an aircraft, a vehicle component, a robot, or a data center.

Optionally, the fastening body is rotated to allow the fastening body to fasten to the fastened body, and the fastening body is provided with an elastic component, or the elastic component presses against an object to apply a force for the fastening body to pop in, elastically fasten, rebound to fasten, or automatically and elastically retract to fasten to the fastened part, or the elastic component is a spring, a spring plate, a coil spring, an elastic cylinder, or an elastic disk, or the second fastening part elastically fastens, rebounds to fasten, or automatically and elastically retracts to fasten to the fastened part, or the first fastening part is configured to enter the fastened part to prevent rotation with the fastened part.

Optionally, the second fastening part fastens or elastically fastens to the fastened part, or the first fastening part is configured to enter the fastened part to prevent rotation with the fastened part, or the first fastening part is smaller than the second fastening part, the fastened part is larger than the first fastening part and smaller than the second fastening part, and the entering part is larger than the second fastening part.

Optionally, the fastening body is provided with an elastic component for pressing against an object, the second fastening part and the first fastening part pass through a passing part of the object and an entering part of a fastened body to rotate the fastening structure to allow, when the first fastening part reaches a fastened part of the fastened body, the first fastening part to automatically and elastically fasten, elastically fasten into, or rebound to fasten into the fastened part, or retract to fasten, or the first fastening part to enter the fastened part to prevent rotation with the fastened part, or the second fastening part to elastically fasten, rebound to fasten, or automatically and elastically retract to fasten to the fastened part.

Optionally, the fastening body is provided with an elastic component for pressing against an object, the second fastening part and the first fastening part pass through a passing part of the object and an entering part of the fastening body to rotate the fastening structure to allow, when the second fastening part reaches a fastened part of the fastening body, the second fastening part to automatically and elastically fasten, elastically fasten into, or rebound to fasten into the fastened part, or automatically and elastically retract or fasten to the fastened part, or elastically fasten, elastically fasten into, or rebound to fasten into the fastened part, or elastically retract to fasten to the fastened part.

Optionally, the fastening body is rotated to allow the fastening body to fasten to the fastened body, the fastening body is provided with an elastic component or an intermediate body, or the elastic component presses against the intermediate body, and the intermediate body presses against the object.

Optionally, the elastic component is a spring, a spring plate, an elastic cylinder, or an elastic disk, or the intermediate body is a sheet, a spring washer, an elastic component, an elastomer, a metal body, a plastic body, a non-metal body, a barrel, a cylinder, or a hollow body, or the elastic component is an intermediate body.

Optionally, the second fastening part and the first fastening part pass through a passing part of an object, the passing part is a hole part, a circular hole, a slotted hole, an elliptical hole, an irregular-shaped hole, a quadrate hole, a square hole, a rectangular hole, a slot part, an elongated structure, a circular structure, or a structure corresponding to the entering part, or the fastening body has a rod part, the rod part is smaller than the passing part, or the passing part is an anti-rotation part configured to prevent rotation with the first fastening part, the second fastening part, or the rod part, or the passing part is an anti-rotation part configured to prevent rotation with the first fastening part, the second fastening part, or the rod part, and the passing part is a hole part, a slotted hole, an elliptical hole, an irregular-shaped hole, a quadrate hole, a square hole, a rectangular hole, a slot part, or an elongated structure to prevent rotation.

Optionally, the fastening body includes two separately disposed fastening parts, or the fastening body is a fastening part disposed individually, or the second fastening part includes two convex fastening bodies, or the second fastening part is a convex fastening body.

Optionally, the second fastening part includes two convex fastening bodies, where the second fastening part is a convex fastening body.

Optionally, the fastening structure has a limiting body configured to connect the fastening body to the object, the limiting body is located between the object and the fastened body, or the fastening body has a limiting part configured to limit the limiting body, or the limiting body is a C-shaped fastener, a lateral fastening body, or a straight fastening body, or the limiting part is a concave part, a convex part, or a slot part.

Optionally, the fastening body has an operation part configured to operate or configured to operate by using a tool, or has a restriction area higher than the operation part, the restriction area is configured to restrict transverse movement of the tool when the operation part is operated, or the restriction area is configured to restrict transverse movement of the tool from exceeding the restriction area when the operation part is operated, or the operation part is straight line-shaped, cross-shaped, flower-shaped, polygon-shaped, polyheon-shaped, a convex body, or a concave body, or the fastening body is movably connected to a body part, or the body part has a connecting part, or is configured to elastically connect or elastically fasten to the object.

Optionally, the fastening structure further includes a body part, the fastening body is movably disposed on the body part, or the body part is provided with a connecting part, or the connecting part is configured to rivet, fasten, expand, weld, or lock to an object, or the connecting part is integrally formed on an object, or the connecting part has an elastic fastening part for elastically fasten and connect to the object.

Optionally, the first fastening part or the second fastening part is a T-shape, a T-shape with steps, a T-shape with a protrusion, a T-shape with protrusions on two sides, an L-shape with a protrusion on one side, an approximate T-shape, an approximate L-shape, an approximate T-shape with a protrusion, an approximate L-shape with a protrusion, an approximate T-shape with protrusions on two sides, an approximate L-shape with protrusions on two sides, or an approximate T-shape with steps, or a combination of the first fastening part or the second fastening part is a T-shape, a T-shape with steps, a T-shape with a protrusion, a T-shape with protrusions on two sides, an L-shape with a protrusion on one side, an approximate T-shape, an approximate L-shape, an approximate T-shape with a protrusion, an approximate L-shape with a protrusion, an approximate T-shape with protrusions on two sides, an approximate L-shape with protrusions on two sides, or an approximate T-shape with steps, or the first fastening part is smaller than the second fastening part, the fastened part is larger than the first fastening part and is smaller than the second fastening part, and the entering part is larger than the second fastening part.

Optionally, the fastening body is provided with an elastic component configured to press against an object, the second fastening part and the first fastening part pass through a passing part of the object and an entering part of the fastened body to rotate the fastening structure to allow, when the second fastening part reaches a fastened part of the fastening body, the second fastening part to automatically and elastically fasten, elastically fasten into, or rebound to fasten into the fastened part, or automatically and elastically retract or fasten to the fastened part, or elastically fasten, elastically fasten into, or rebound to fasten into the fastened part, or elastically retract to fasten to the fastened part.

Optionally, the fastening body is provided with an elastic component for pressing against an object, the second fastening part and the first fastening part pass through a passing part of the object and an entering part of the fastened body to rotate the fastening structure to allow, when the second fastening part reaches a fastened part of the fastened boy, the second fastening part to automatically and elastically fasten, elastically connect, elastically fasten into, or rebound to fasten into the fastened part or automatically and elastically retract to fasten to the fastened part, or elastically fasten, elastically fasten into, or rebound to fasten into the fastened part or elastically retracts to fasten to the fastened part.

Optionally, the fastening body and the body part respectively have a fastening part, and the fastener parts are configured to fasten to each other to compress or stretch the fastened body or the object, or the fastener parts are internal teeth or external teeth, or configured to compress or stretch the fastened body and the object.

Optionally, the fastening body further includes a head part, the head part is configured for the combination part to connect the fastening body, and the head part is a rotating body and is configured to rotate and squeeze or apply a force to an elastic component to cooperate the second fastening part to compress or stretch the fastened body or the object, or is configured to compress or stretch the fastened body or the object.

Optionally, the combination part is located and moves at a high position or a low position, and is configured to rotate and squeeze or apply a force to the elastic component.

Optionally, after the head is rotated to change an angle, the combination part is located and moves at the high position or the low position, and is configured to rotate and squeeze or apply the force to the elastic component.

Optionally, the fastening structure penetrates through the object to fasten to the fastened body, the object dissipates heat for a heating body, or the object is a heat dissipation body.

Optionally, a body is further included, the fastening body may enter the body, or the fastening body is accommodated in the body.

Optionally, the fastened body is provided with another connecting part, the another connecting part is configured to rivet, expand, weld, lock, fasten, clamp, elastically fasten, bind, or interfere with an object, or the fastened body is provided with another anti-rotation part, and the anti-rotation part is configured to prevent rotation with the object to limit the fastened part and the entering part in a direction of the object.

### BRIEF DESCRIPTION OF THE DRAWINGS

To describe technical solutions in embodiments of the present disclosure or in a prior art more clearly, the following briefly describes the accompanying drawings required for describing the embodiments. Apparently, the accompanying drawings in the following description are merely some embodiments of the present disclosure, and those of ordinary skill in the art may obtain other accompanying drawings from these accompanying drawings without creative work.

FIG. 1 is a schematic diagram of a first specific embodiment of the present disclosure.

FIG. 2 is a schematic diagram of a second specific embodiment of the present disclosure.

FIG. 3 is a schematic diagram of a third specific embodiment of the present disclosure.

FIG. 4 is a schematic diagram of a fourth specific embodiment of the present disclosure.

FIG. 5 is a schematic diagram of a fifth specific embodiment of the present disclosure.

FIG. 6 is a schematic diagram of a sixth specific embodiment of the present disclosure.

FIG. 7 is a schematic diagram of a seventh specific embodiment of the present disclosure.

FIG. 8 is a schematic diagram of a seventh specific embodiment of the present disclosure.

FIG. 9 is a schematic diagram of an eighth specific embodiment of the present disclosure.

FIG. 10 is a schematic diagram of a ninth specific embodiment of the present disclosure.

FIG. 11 is a schematic diagram of a tenth specific embodiment of the present disclosure.

FIG. 12 is a schematic diagram of an eleventh specific embodiment of the present disclosure.

FIG. 13 is a schematic diagram of a twelfth specific embodiment of the present disclosure.

FIG. 14 is a first schematic diagram of a thirteenth specific embodiment of the present disclosure.

FIG. 15 is a second schematic diagram of a thirteenth specific embodiment of the present disclosure.

FIG. 16 is a third schematic diagram of a thirteenth specific embodiment of the present disclosure.

FIG. 17 is a schematic diagram of a thirteenth specific embodiment of the present disclosure.

FIG. 18 is a first schematic diagram of a thirteenth specific embodiment of the present disclosure.

FIG. 19 is a second schematic diagram of a fourteenth specific embodiment of the present disclosure.

FIG. 20 is a first schematic diagram of a fifteenth specific embodiment of the present disclosure.

FIG. 21 is a second schematic diagram of a fifteenth specific embodiment of the present disclosure.

FIG. 22 is a third schematic diagram of a fifteenth specific embodiment of the present disclosure.

FIG. 23 is a schematic diagram 1 of a sixteenth specific embodiment of the present disclosure.

FIG. 24 is a second schematic diagram of a sixteenth specific embodiment of the present disclosure.

FIG. 25 is a schematic diagram 3 of a seventeenth specific embodiment of the present disclosure.

FIG. 26 is a schematic diagram 3 of an eighteenth specific embodiment of the present disclosure.

FIG. 27 is a schematic diagram 3 of a nineteenth specific embodiment of the present disclosure.

FIG. 28 is a schematic diagram of a twentieth specific embodiment of the present disclosure.

FIG. 29 is a schematic diagram of a twenty first specific embodiment of the present disclosure.

FIG. 30 is a schematic diagram of a twenty second specific embodiment of the present disclosure.

FIG. 31 is a schematic diagram of a twenty third specific embodiment of the present disclosure.

FIG. 32 is a schematic diagram of a twenty fourth specific embodiment of the present disclosure.

FIG. 33 is a schematic diagram of a twenty fifth specific embodiment of the present disclosure.

FIG. 34 is a schematic diagram of a twenty sixth specific embodiment of the present disclosure.

FIG. 35 is a schematic diagram of a twenty seventh specific embodiment of the present disclosure.

FIG. 36 is a schematic diagram of a twenty eighth specific embodiment of the present disclosure.

FIG. 37 is schematic diagram of a twenty eighth specific embodiment of the present disclosure.

FIG. 38 is schematic diagram of a twenty ninth specific embodiment of the present disclosure.

FIG. 39 is schematic diagram of a twenty ninth specific embodiment of the present disclosure.

FIG. 40 is a schematic diagram of different forms of an operation part according to the present disclosure.

### DETAILED DESCRIPTION OF THE INVENTION

A fluid binding structure according to embodiments of the present disclosure will be further described below with reference to accompanying drawings.

The foregoing and other technical content, features, and effects related to the present disclosure can be clearly presented in the following detailed description of preferred embodiments with reference to the accompanying drawings. It is worth mentioning that directional terms such as upper, lower, left, right, front, or rear mentioned in the following embodiments are only directions with reference to the accompanying drawings. Therefore, used directional terms are used for description, but are not intended to limit the present disclosure. In addition, in the following embodiments, the same or similar components use the same or similar numbers.

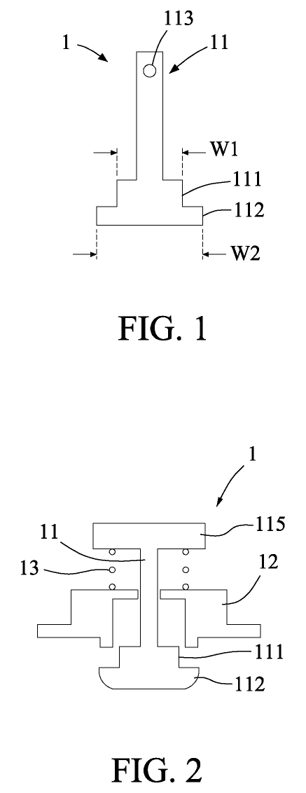

As shown in FIG. 1, the present disclosure is a fastening structure. The fastening structure 1 at least includes: a fastening body 11, including a first fastening part 111 and a second fastening part 112. The first fastening part 111 is configured to rotate after penetrating through (or passing through) an entering part 102 of a fastened body 10 to allow the second fastening part 112 to fasten into (or fasten to) a fastened part 101 of the fastened body 10, that is, the fastening body 11 may be rotated to allow the fastening body 11 to fasten to the fastened body 10. The first fastening part 111 and the second fastening part 112 may be fastened to the fastened part 101 of the same fastened body 10 or fastened to fastened parts 101 of different fastened bodies 10. In this way, quick combination and separation of at least two objects can be completed by means of cooperation of the first fastening part 111 and the second fastening part 112 of the fastening body 11, thereby achieving effects of repeated quick combination and separation.

Based on the foregoing embodiment, in a method for assembling the fastening structure according to the present disclosure, the fastening body 11 may be operated to allow the first fastening part 111 to penetrate through (or pass through) the entering part 102 of the fastened body 10, and then the fastening body 11 is rotated to allow the second fastening part 112 to fasten to the fastened part 101. In this way, quick combination and separation of at least two objects can be completed by means of cooperation of the first fastening part 111 and the second fastening part 112 of the fastening body 11, thereby achieving effects of repeated quick combination and separation.

In addition to the foregoing embodiment, in an embodiment of the present disclosure, the embodiment differs from the foregoing embodiment in that a width w1 of the first fastening part 111 may be greater than a width w2 of the second fastening part 112, the first fastening part 111 and the second fastening part 112 are located at a bottom of the fastening body 11, and a combination part 113 is provided at a top end of the fastening body 11, where the combination part 113 may be connected to related components that are required. Therefore, the present disclosure can better meet requirements of actual applications.

In addition to the foregoing embodiment, in an embodiment of the present disclosure, the embodiment differs from the foregoing embodiment in that the fastened body 10 may be an ironed part, a plastic part, a PCB, a radiator, an IC, a memory, a water-cooled component, a handle, a fan, a power supply, a fastener, a fastening piece, a connector, a case, a cabinet, a computer, an aircraft, a vehicle component, a robot, or a data center. In this way, the present disclosure can better meet requirements of actual applications.

In addition to the foregoing embodiment, in an embodiment of the present disclosure, the embodiment differs from the foregoing embodiment in that each of the first fastening part 111 and the second fastening part 112 may be a T-shape, a T-shape with steps, a T-shape with a protrusion, a T-shape with protrusions on two sides, an L-shape with a protrusion on one side, an approximate T-shape, an approximate L-shape, an approximate T-shape with a protrusion, an approximate L-shape with a protrusion, an approximate T-shape with protrusions on two sides, an approximate L-shape with protrusions on two sides, or an approximate T-shape with steps, or a combination of the first fastening part or the second fastening part is a T-shape, a T-shape with steps, a T-shape with a protrusion, a T-shape with protrusions on two sides, an L-shape with a protrusion on one side, an approximate T-shape, an approximate L-shape, an approximate T-shape with a protrusion, an approximate L-shape with a protrusion, an approximate T-shape with protrusions on two sides, an approximate L-shape with protrusions on two sides, or an approximate T-shape with steps. In this way, the first fastening part 111 and the second fastening part 112 can better meet requirements of actual applications.

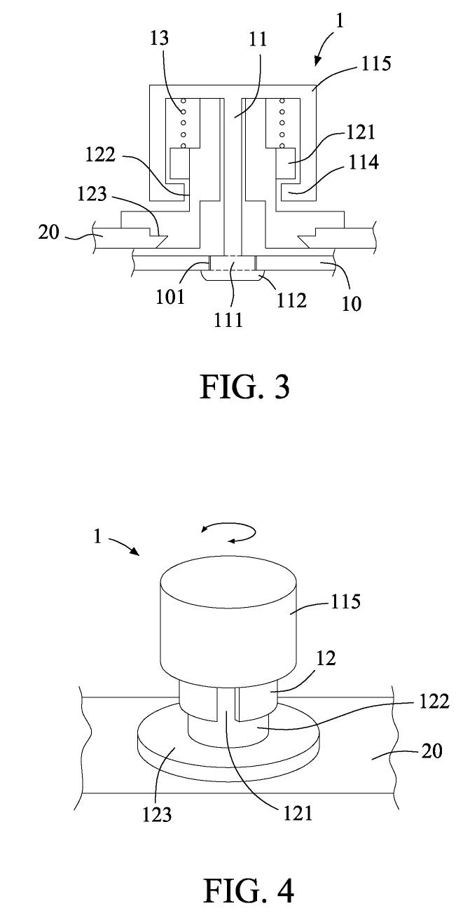

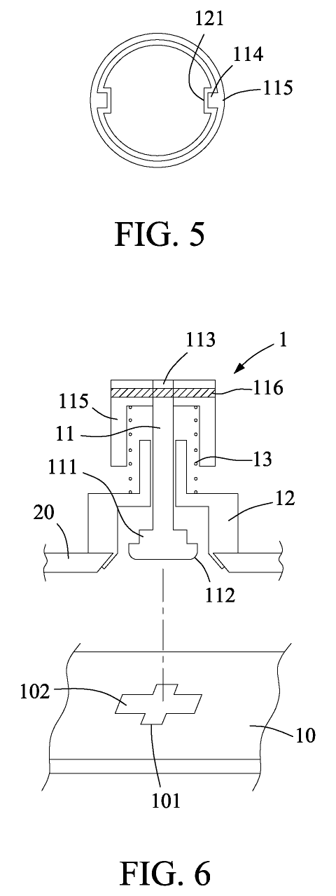

As shown in FIGS. 2 to 5, in addition to the foregoing embodiment, in an embodiment of the present disclosure, the embodiment differs from the foregoing embodiment in that the fastening structure 1 further includes a body part 12, the fastening body 11 is movably disposed on the body part 12, or the body part 12 is provided with an elastic component 13, and two ends of the elastic component 13 respectively press against the fastening body 11 and the body part 12, or the second fastening part 112 elastically fastens, elastically fastens into, or rebounds to fasten into a fastened part 101 of the fastened body 10 by means of an elastic force of the elastic component 13, and the first fastening part 111 elastically and automatically retracts into the fastened part 101 to prevent rotation with the fastened part 101. In this way, the fastening body 11 of the fastening structure 1 allows the second fastening part 112 to stably fasten to the fastened part 101 by means of cooperation of the elastic component 13.

In addition to the foregoing embodiment, in an embodiment of the present disclosure, the embodiment differs from the foregoing embodiment in that the body part 12 is provided with a limiting part 121 and a rotation space 122, the fastening body 11 further includes a head part 115, the head part 115 is provided with an alignment part 114, the alignment part 114 is limited in the limiting part 121 to move to allow the first fastening part 111 to enter the entering part 102 of the fastened body 10 and allow the alignment part 114 to rotate in the rotation space 122 to allow the second fastening part 112 to fasten to the fastened part 101, where the rotation space 122 may be a 360-degree full-perimeter structure, or the rotation space 122 may be a non-360-degree non-full-perimeter structure, or the rotation space 122 may be a full-perimeter structure of 30 degrees to 180 degrees, or the rotation space 122 may be a non-full-perimeter structure of 30 degrees to 270 degrees.

In addition to the foregoing embodiment, in an embodiment of the present disclosure, the embodiment differs from the foregoing embodiment in that the body part 12 is provided with a connecting part 123, and the connecting part 123 is configured to rivet, fasten, expand, weld, or lock to an object 20, or the connecting part 123 is integrally formed on the object 20.

In addition to the foregoing embodiment, in an embodiment of the present disclosure, the embodiment differs from the foregoing embodiment in that the fastening body 11 has a head part 115, and the head part 115 may be rotated to allow the second fastening part 112 to fasten to the fastened part 101, and allow the first fastening part 111 to enter the fastened part 101 to prevent rotation with the fastened part 101.

Based on the foregoing embodiment, the fastening structure 1 may be combined to the object 20 by using the connecting part 123 of the body part 12, and the head part 115 of the fastening body 11 is operated to allow the first fastening part 111 to penetrate through (pass through) the fastened part 101 of the fastened body 10, and then the fastening body 11 is rotated to allow the second fastening part 112 to elastically fasten to the fastened part 101 by means of an elastic force of the elastic component 13. In this way, quick combination and separation of at least two objects can be completed by means of cooperation of the first fastening part 111 and the second fastening part 112 of the fastening body 11, thereby achieving effects of repeated quick combination and separation.

As shown in FIGS. 6 to 8, in addition to the foregoing embodiment, in an embodiment of the present disclosure, the embodiment differs from the foregoing embodiment in that the head part 115 is combined with the fastening body 11 through cooperation of a bolt body 116 and the combination part 113.

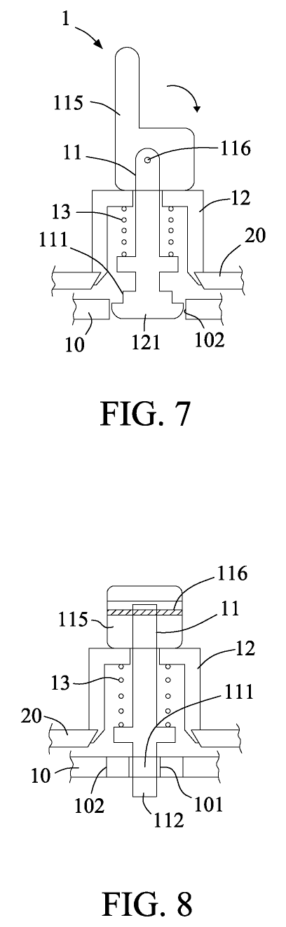

During use (as shown in FIGS. 7 and 8), the head part 115 may be first rotated to allow the second fastening part 112 to be located at a fastening position corresponding to the fastened part 101, and then the head part 115 is flipped or pulled to allow the head part 115 to change a position on the body part 12, allow the first fastening part 111 to penetrate through (or pass through the fastened part 101 of the fastened body 10, allow the second fastening part 112 fastens to the fastened part 101, and allow the first fastening part 111 to enter the fastened part 101 to prevent rotation with the fastened part 101. Further, quick combination and separation of at least two objects can be completed by means of cooperation of the first fastening part 111 and the second fastening part 112 of the fastening body 11, thereby achieving effects of repeated quick combination and separation.

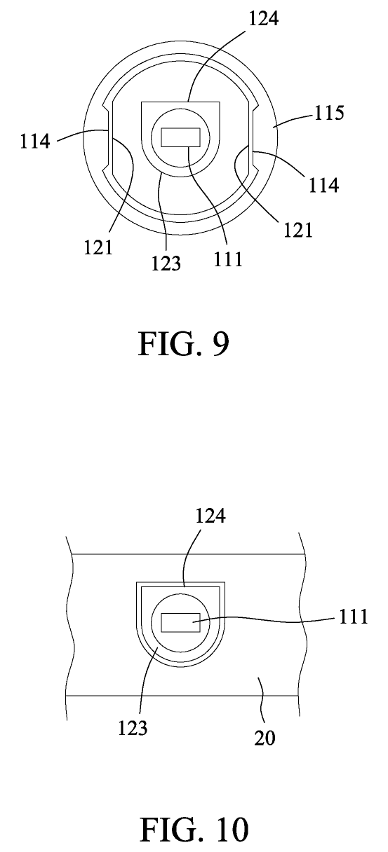

As shown in FIGS. 9 to 11, in addition to the foregoing embodiment, in an embodiment of the present disclosure, the embodiment differs from the foregoing embodiment in that the connecting part 123 is provided with an anti-rotation part 124, and the anti-rotation part 124 is configured to prevent rotation with the object 20, limit a position, or limit a direction. In this way, the present disclosure can better meet requirements of actual applications.

In addition to the foregoing embodiment, in an embodiment of the present disclosure, the embodiment differs from the foregoing embodiment in that the anti-rotation part 124 may limit a direction of the first fastening part 111 or the second fastening part 112. In this way, the present disclosure can better meet requirements of actual applications.

In addition to the foregoing embodiment, in an embodiment of the present disclosure, the embodiment differs from the foregoing embodiment in that the anti-rotation part 124 corresponds to the limiting part 121 and the alignment part 114 to limit a direction of the first fastening part 111 or the second fastening part 112. In this way, the present disclosure can better meet requirements of actual applications.

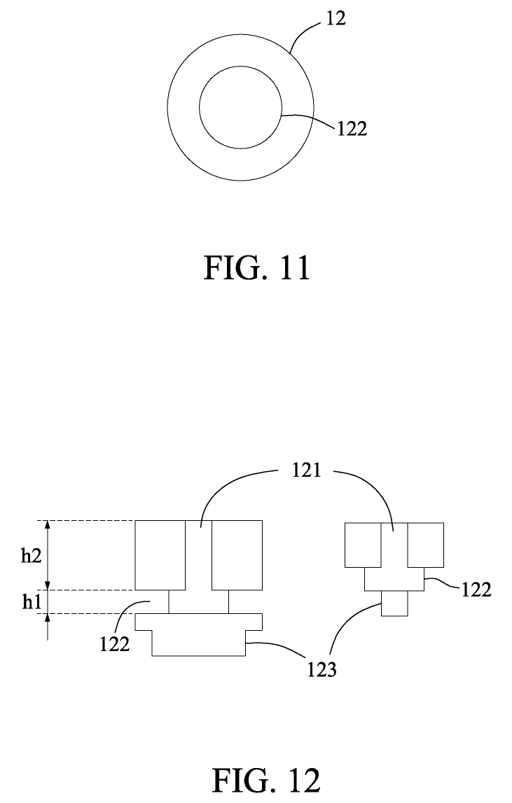

In addition to the foregoing embodiment, in an embodiment of the present disclosure, the embodiment differs from the foregoing embodiment in that the rotation space 122 is a 360-degree full-perimeter structure (as shown in FIG. 11), or the rotation space is a non-360-degree non-full-perimeter structure. In this way, the present disclosure can better meet requirements of actual applications.

In addition to the foregoing embodiment, in an embodiment of the present disclosure, the embodiment is differs from the foregoing embodiment in that the limiting part 121, the rotation space 122, or the alignment part 114 may be a convex body, a concave body, a planar body, a cambered body, a curved body, a barrier body, a hole body, a ring body, or a cross-sectional body. In this way, the present disclosure can better meet requirements of actual applications.

As shown in FIG. 12, in addition to the foregoing embodiment, in an embodiment of the present disclosure, the embodiment differs from the foregoing embodiment in that the rotation space 122 has a height stroke h1 for activities and movement of the alignment part 114, the limiting part 121 has a height stroke h2 for activities and movement of the alignment part 114, or a stroke of the second fastening part 112 fastened to the fastened part 101 is equal to (or less than) the height stroke h1 of the rotation space 122, or a maximum stroke of the first fastening part 111 penetrating through (or passing through) the fastened body 10 is equal to (or less than) the height stroke h2 of the limiting part 121 and the height stroke h1 of the rotation space 122. In this way, the first fastening part 111 may penetrate through (or pass through) the fastened part 101 of the fastened body 10, and then is fastened to the fastened part 101 by means of the second fastening part 112, to complete quick combination and separation of at least two objects, thereby achieving repeated quick combination and separation.

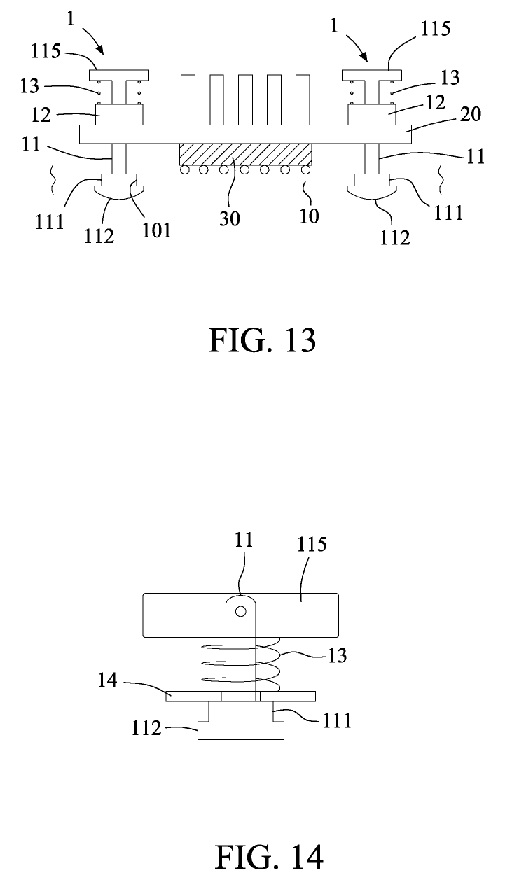

As shown in FIG. 13, in addition to the foregoing embodiment, in an embodiment of the present disclosure, the embodiment differs from the foregoing embodiment in that the object 20 may be a heat dissipation body, a heating body 30 is disposed between the object 20 and the fastened body 10, the fastening body 11 is fastened to the fastened part 101 of the fastened body 10 by using the first fastening part 111 and the second fastening part 112, and a pressing force is applied on the object 20 (the heat dissipation body) by means of cooperation of the elastic component 13, so that the object 20 (the heat dissipation body) stably fits the heating body 30 to dissipate heat.

In addition to the foregoing embodiment, in an embodiment of the present disclosure, the embodiment differs from the foregoing embodiment in that the heating body 30 may be an IC, a CPU, a GPU, a memory, a chip, or a battery; the fastened body 10 may be a circuit board, a metal body, a plastic body, a fastening piece, or a fastening piece connected to another object; and the heating body 30 is connected to the fastened body 10 by means of welding, fastening, or using a connector; or the fastened body 10 is an ironed part, a plastic part, a PCB, a printed circuit board, a radiator, an IC, a memory, a water-cooled component, a handle, a fan, a power supply, a fastener, a fastening piece, a connector, a case, a cabinet, a computer, an aircraft, a vehicle component, a robot, or a data center. In this way, the present disclosure can better meet requirements of actual applications.

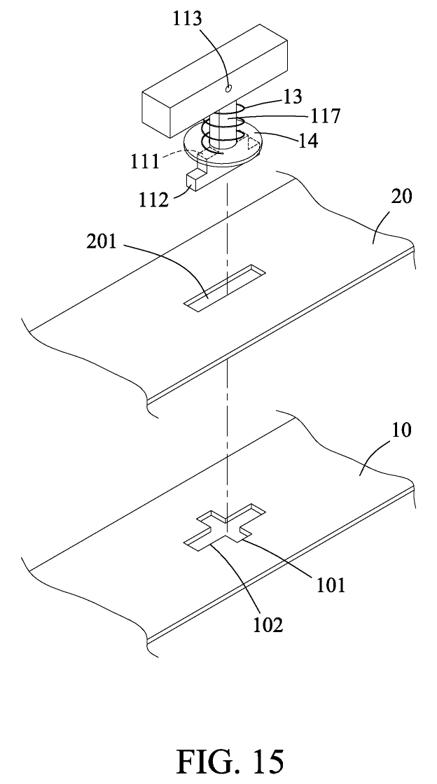

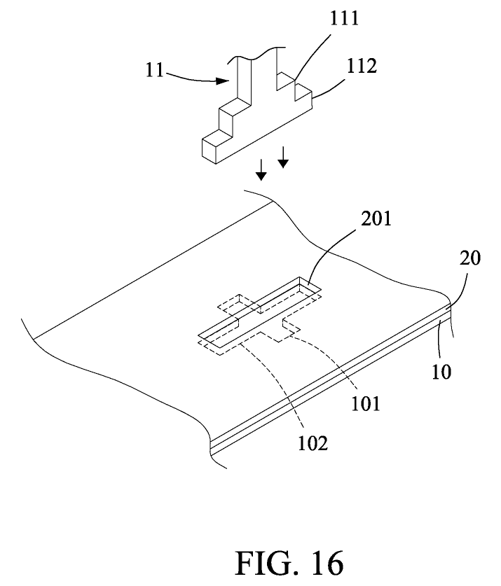

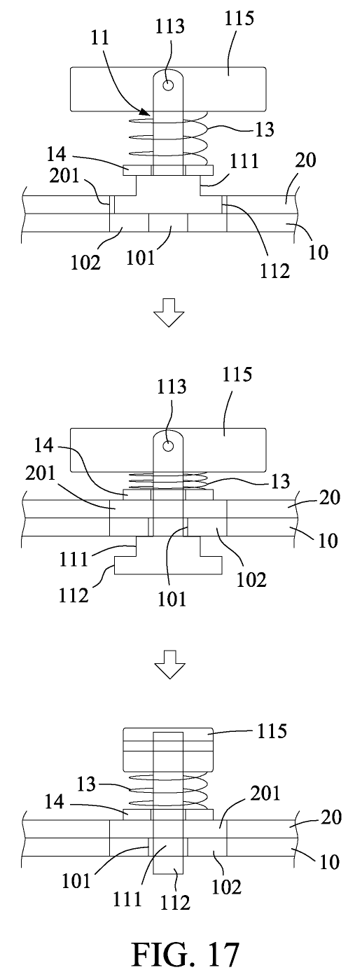

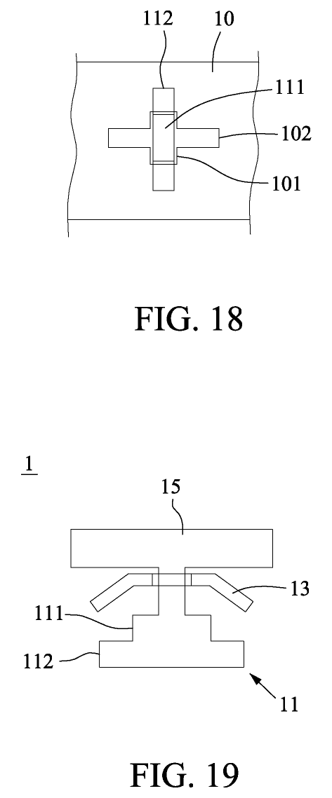

As shown in FIGS. 14 to 19, in addition to the foregoing embodiment, in an embodiment of the present disclosure, the embodiment differs from the foregoing embodiment in that the fastening body 11 includes a first fastening part 111 and a second fastening part 112. The second fastening part 112 and the first fastening part 111 pass through a passing part 201 of the object 20 and an entering part 102 of the fastened body 10 to rotate the fastening body 11, allowing the first fastening part 111 to fasten into the fastened part 101 of the fastened body 10. In this way, the fastening structure 1 can complete quick combination and separation of at least two objects (the object 20 and the fastened body 10) by means of cooperation of the first fastening part 111 and the second fastening part 112 of the fastening body 11, thereby achieving effects of repeated quick combination and separation.

In addition to the foregoing embodiment, in an embodiment of the present disclosure, the embodiment differs from the foregoing embodiment in that the elastic component 13 presses against the object 20 to apply a force for the first fastening body 111 of the fastening body 11 to pop in, elastically fasten, rebound to fasten, or automatically and elastically retract to fasten to the fastened part 101. The elastic component 13 is a spring, a spring plate, a coil spring, an elastic cylinder, or an elastic disk (as shown in FIG. 19), the second fastening part 112 fastens or elastically fastens to the fastened part 101, the first fastening part 111 is configured to enter the fastened part 101 to prevent rotation with the fastened part 101, the first fastening part 111 is smaller than the second fastening part 112, the fastened part 101 is larger than the first fastening part 111 and smaller than the second fastening part 112, and the entering part 102 is larger than the second fastening part 112. In this way, the elastic component 13 can better meet requirements of actual applications.

In addition to the foregoing embodiment, in an embodiment of the present disclosure, the embodiment differs from the foregoing embodiment in that the passing part 201 may be a hole part, a circular hole, a slotted hole, an elliptical hole, an irregular-shaped hole, a quadrate hole, a square hole, a rectangular hole, a slot part, an elongated structure, a circular structure, or a structure corresponding to the entering part 102, and the fastening body 11 has a rod part 117, where the rod part 117 is smaller than the passing part 201. In this way, the passing part 201 can better meet requirements for actual applications when the second fastening part 112 and the first fastening part 111 pass through or are fastened.

In addition to the foregoing embodiment, in an embodiment of the present disclosure, the embodiment differs from the foregoing embodiment in that the elastic component 13 presses against the intermediate body 14, and the intermediate body 14 presses against the object 20. The intermediate body 14 may be a sheet, a spring washer, an elastic component, an elastomer, a metal body, a plastic body, a non-metal body, a barrel, a cylinder, or a hollow body, or the elastic component 13 is an intermediate body 14. In this way, the elastic component 13 may cooperate with the intermediate body 14 to allow the first fastening part 111 to fasten into the fastened part 101 of the fastened body 10 more stably.

In addition to the foregoing embodiment, in an embodiment of the present disclosure, the embodiment differs from the foregoing embodiment in that the passing part 201 may be an anti-rotation part, configured to prevent rotation with the first fastening part 111, the second fastening part 112, or the rod part 117, or the passing part 201 may be an anti-rotation part, configured to prevent rotation with the first fastening part 111, the second fastening part 112, or the rod part 117, where the passing part is a hole part, a slotted hole, an elliptical hole, an irregular-shaped hole, a quadrate hole, a square hole, a rectangular hole, a slot part, or an elongated structure, configured to prevent rotation. In this way, the passing part 201 can better meet requirements for actual applications the second fastening part 112 and the first fastening part 111 pass or are fastened.

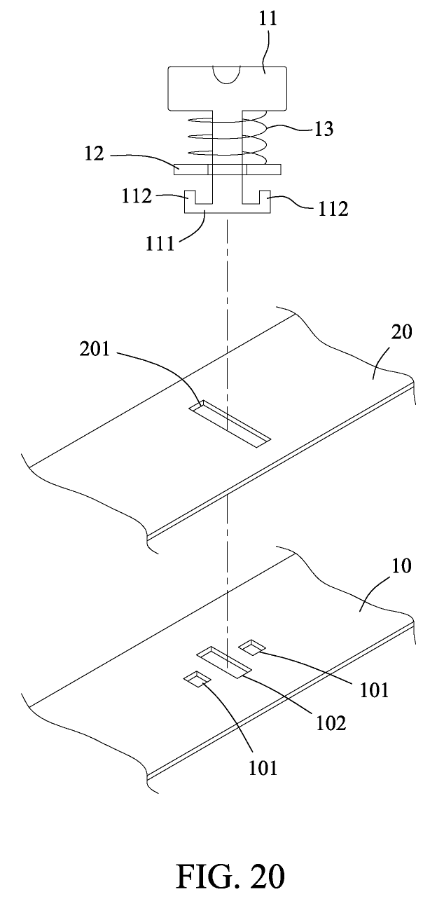

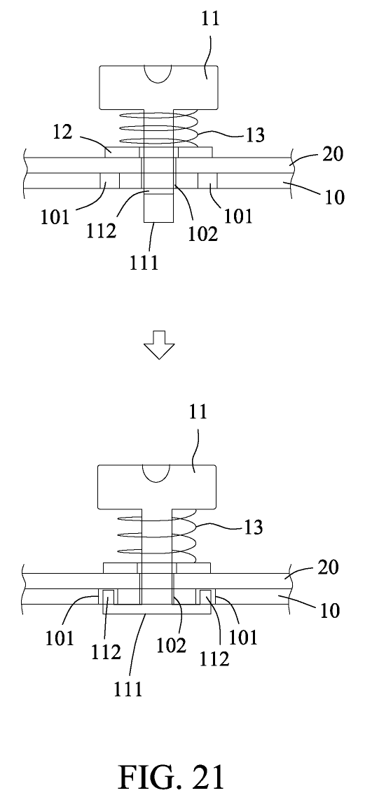

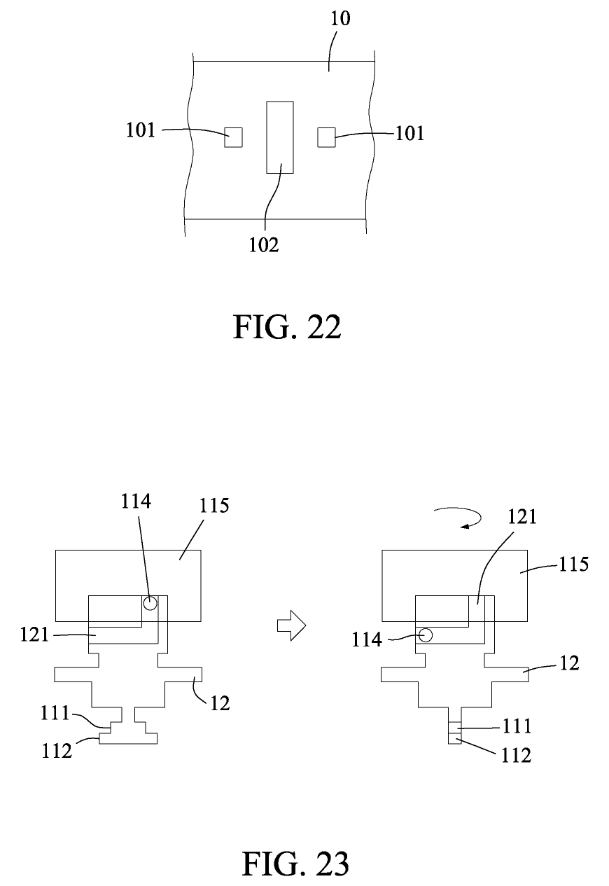

As shown in FIGS. 20 to 22, in addition to the foregoing embodiment, in an embodiment of the present disclosure, the embodiment differs from the foregoing embodiment in that the fastened body 10 may include two separately disposed fastened parts 101 (or the fastened body 10 is a fastened part 101 disposed individually), and the second fastening part 112 may include two convex fastening bodies (the second fastening part 112 is a convex fastening body). The first fastening part 111 and the second fastening part 112 may pass through a passing part 201 of the object 20 and an entering part 102 of the fastened body 10 to rotate the fastening body 11, allowing the second fastening parts 112 to respectively fasten into the fastened parts 101 of the fastened bodies 10. In this way, the fastening structure 1 can complete quick combination and separation of at least two objects (the object 20 and the fastened body 10) by means of cooperation of the first fastening part 111 and the second fastening part 112 of the fastening body 11, thereby achieving effects of repeated quick combination and separation.

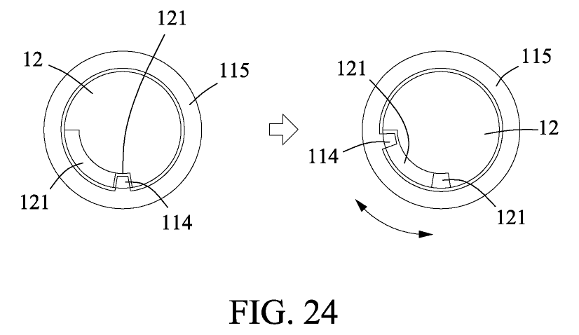

As shown in FIGS. 23 and 24, in addition to the foregoing embodiment, in an embodiment of the present disclosure, the embodiment differs from the foregoing embodiment in that the limiting part 121 may be an L-shaped structure, an L-shaped slot, or a longitudinally and transversely connected structure. The head part 115 may be rotated to allow the alignment part 114 to rotate on the limiting part 121 longitudinally first and then transversely, thereby driving the first fastening part 111 and the second fastening part 112. In this way, the present disclosure can better meet requirements of actual applications.

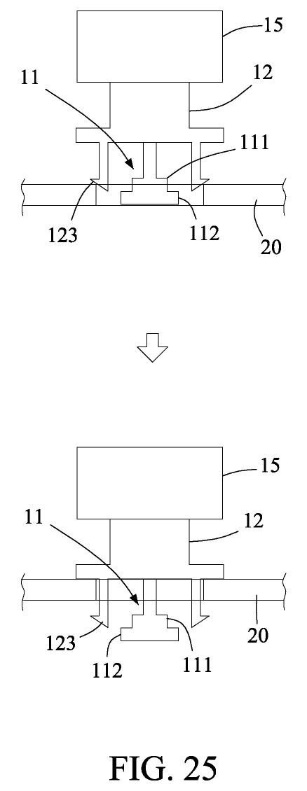

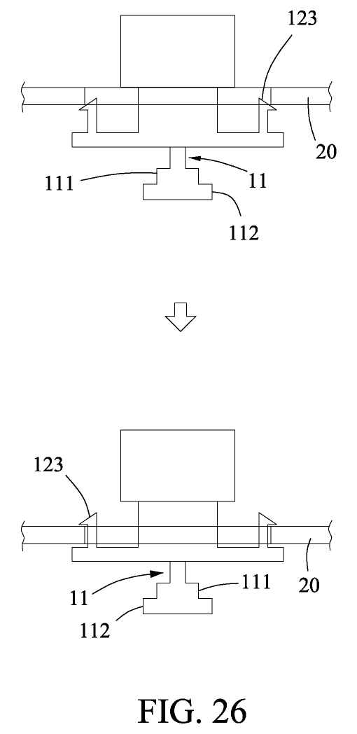

As shown in FIGS. 25 to 27, in addition to the foregoing embodiment, in an embodiment of the present disclosure, the embodiment differs from the foregoing embodiment in that the connecting part 123 may include two elastic fastening bodies to allow the connecting part 123 to elastically fasten to the object 20. In this way, the present disclosure can better meet requirements of actual applications.

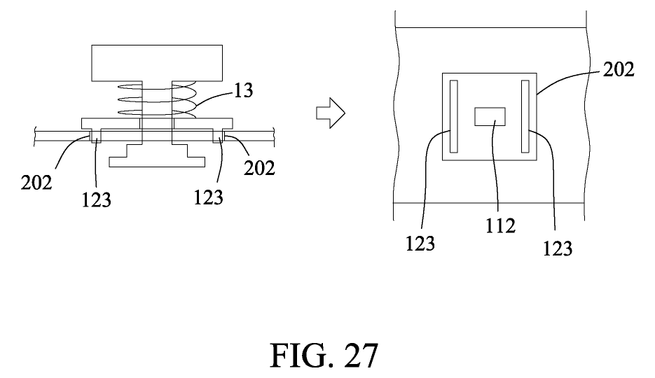

In addition to the foregoing embodiment, in an embodiment of the present disclosure, the embodiment differs from the foregoing embodiment in that the connecting part 123 may serve as an anti-rotation part (as shown in FIG. 27) to prevent rotation with a corresponding anti-rotation part 202 of the object 20, limit a position, or limit a direction. In this way, the present disclosure can better meet requirements of actual applications.

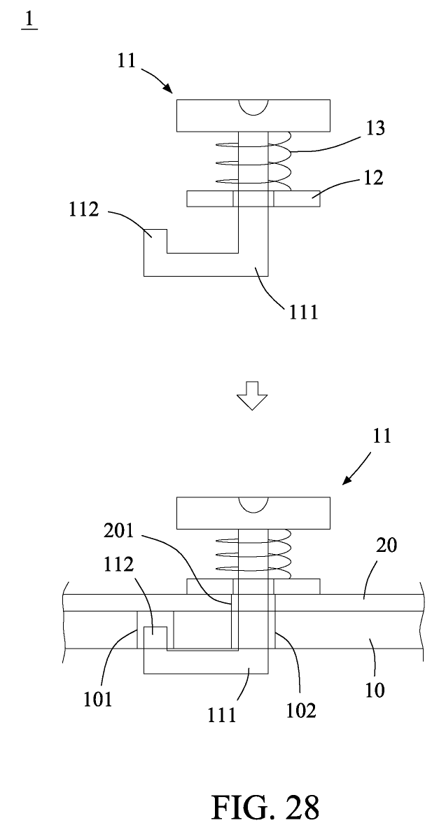

As shown in FIG. 28, in addition to the foregoing embodiment, in an embodiment of the present disclosure, the embodiment differs from the foregoing embodiment in that the second fastening part 112 and the first longitudinal part 111 pass through a passing part 201 of the object 20 and an entering part 102 of the fastened body 10, to rotate the fastening body 11 of the fastening structure 1 to allow, when the second fastening part 112 (or the first fastening part 111) reaches the fastened part 101 of the fastened body 10, the second fastening part 112 (or the first fastening part 111) to fasten, elastically fasten, elastically fasten into, rebound to fasten into or automatically and elastically retract to fasten to the fastened part 101 or elastically retract to fasten to the fastened part 101 through cooperation of the elastic component 13, or automatically and elastically fasten, elastically fasten into, or rebound to fasten into the fastened part 101 or elastically retract to automatically and elastically retract to fasten to the fastened part 101. In this way, the fastening body 11 of the present disclosure can better meet requirements of actual applications.

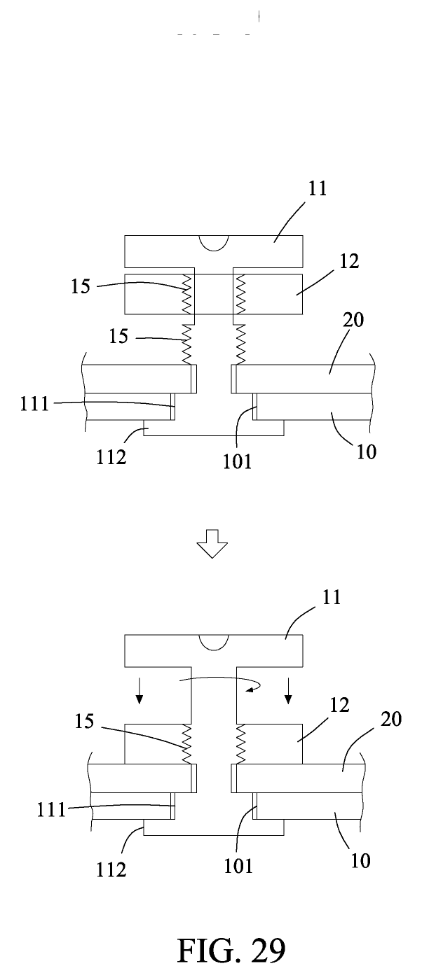

As shown in FIG. 29, in addition to the foregoing embodiment, in an embodiment of the present disclosure, the embodiment differs from the foregoing embodiment in that the fastened part 101 includes two separately disposed fastened parts, the second fastening part 112 includes two convex fastening bodies, and the fastening body 11 and the body part 12 respectively have a fastening part 15. The fastening parts 15 may be an inner tooth part or an outer tooth part, and the fastening parts 15 are configured to fasten to each other to compress or stretch the fastened body 10 or the object 20. In this way, the fastening structure 1 of the present disclosure can better meet requirements of actual applications.

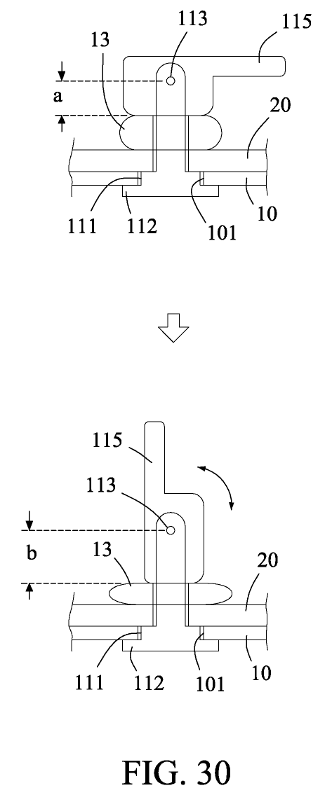

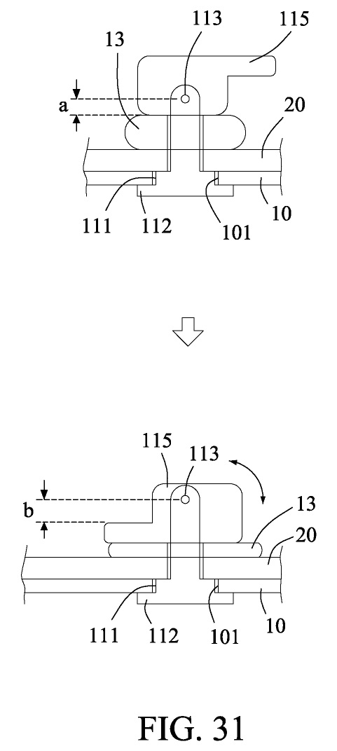

As shown in FIGS. 30 and 31, in addition to the foregoing embodiment, in an embodiment of the present disclosure, the embodiment differs from the foregoing embodiment in that the head part 115 of the fastening body 11 may be a rotating body, configured to rotate and squeeze or apply a force to the elastic component 13, to cooperate with the second fastening part 112 to compress or stretch the fastened body 10 or the object 20. In this way, the fastening structure 1 of the present disclosure can better meet requirements of actual applications.

In addition to the foregoing embodiment, in an embodiment of the present disclosure, the embodiment differs from the foregoing embodiment in that, after the head part 115 is rotated to change an angle (for example, rotated by approximately 90 degrees, as shown in FIG. 30, or rotated by approximately 180 degrees, as shown in FIG. 31), the combination part 113 may be located and move at a high position a or a low position b to rotate and squeeze or apply a force to the elastic component 13. In this way, the fastening structure 1 of the present disclosure can better meet requirements of actual applications.

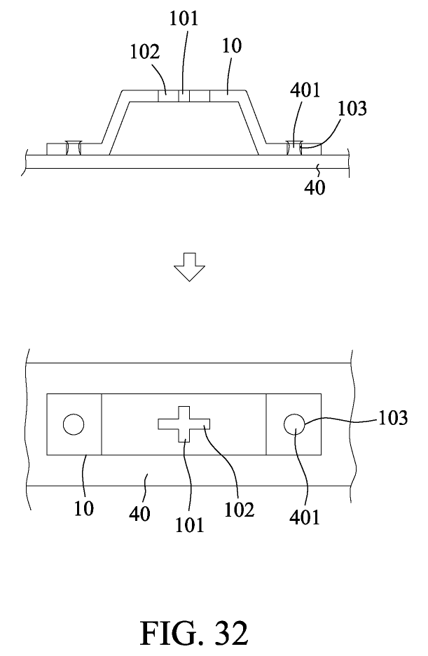

As shown in FIG. 32, in addition to the foregoing embodiment, in an embodiment of the present disclosure, the embodiment differs from the foregoing embodiment in that a fastened body 10 may be a fastening piece connected to another object 40, and the fastened body 10 is connected to an abutment part 401 of the another object 40 by using a combination part 103 (for example, a rivet combination of a through hole and a convex column), for the fastening structure 1 to fasten for use. In this way, the present disclosure can better meet requirements for actual applications.

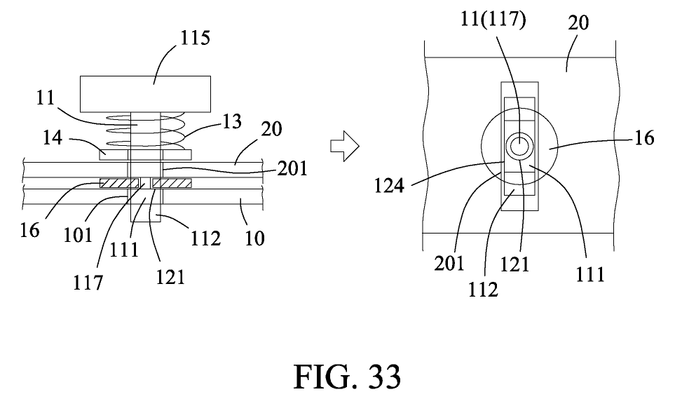

As shown in FIG. 33, in addition to the foregoing embodiment, in an embodiment of the present disclosure, the embodiment differs from the foregoing embodiment in that the present disclosure has a limiting body 16 configured to connect the fastening body 11 to the object 20. The limiting body 16 is located between the object 20 and the fastened body 10, the limiting part 121 is configured to limit the limiting body 16, and the first fastening part 111, the second fastening part 112, and the passing part 201 of the object 20 are prevented from being rotated by using the anti-rotation part 124. In this way, the present disclosure can better meet requirements of actual applications.

In addition to the foregoing embodiment, in an embodiment of the present disclosure, the embodiment differs from the foregoing embodiment in that the limiting body 16 may be a C-shaped fastener, a lateral fastening body, or a straight fastening body, and the limiting part 121 may be a concave part, a convex part, or a slot part. In this way, the present disclosure can better meet requirements of actual applications.

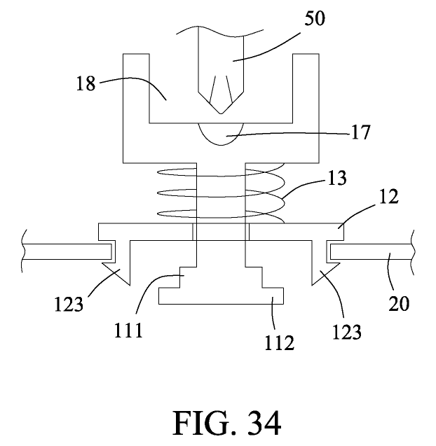

As shown in FIG. 34, in addition to the foregoing embodiment, in an embodiment of the present disclosure, the embodiment differs from the foregoing embodiment in that the fastening body 11 has an operation part 17 configured to operate or configured to operate by using a tool 50, and has a restriction area 18 higher than the operation part 17. The restriction area 18 is configured to restrict transverse movement of the tool 50 when the operation part 17 is operated, or the restriction area 18 is configured to restrict the transverse movement of the tool 50 from exceeding the restriction area 18 when the operation part 17 is operated. In this way, the present disclosure can better meet requirements of actual applications.

In addition to the foregoing embodiment, in an embodiment of the present disclosure, the embodiment differs from the foregoing embodiment in that the operation part 17 may be straight line-shaped, cross-shaped, flower-shaped, polygon-shaped, polyheon-shaped (for example, a hexagon), a convex body, or a concave body. In this way, the operation part 17 of the present disclosure can better meet requirements of actual applications.

In addition to the foregoing embodiment, in an embodiment of the present disclosure, the embodiment differs from the foregoing embodiment in that the fastening body 11 is movably connected to the body part 12, the body part 12 has a connecting part 123, and the connecting part 123 includes two elastic fastening bodies, configured to elastically connect or elastically fasten to the object 20. In this way, the present disclosure can better meet requirements for actual applications.

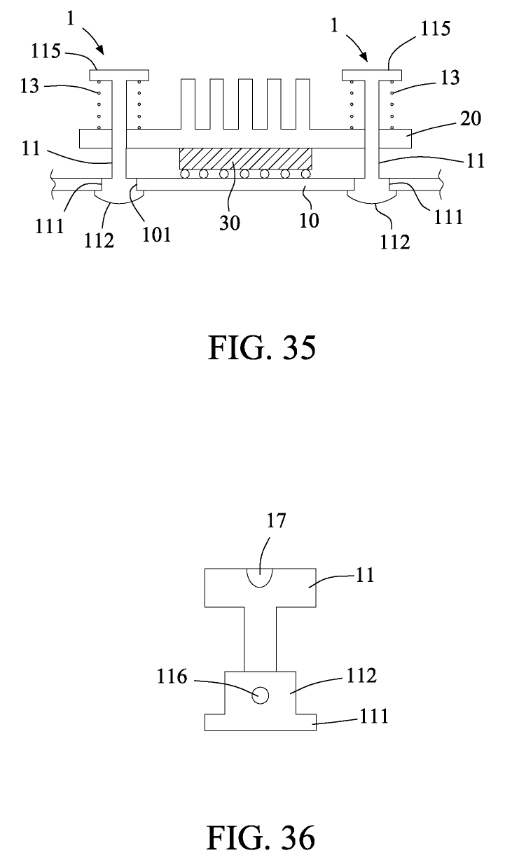

As shown in FIG. 35, in addition to the foregoing embodiment, in an embodiment of the present disclosure, the embodiment differs from the foregoing embodiment in that the object 20 may be a heat dissipation body, and the fastening structure 1 penetrates through the object 20 and is fastened to the fastened body 10 (compared with FIG. 13, the body part 12 does not need to be disposed), so that the object 20 (the heat dissipation body) stably fits the heating body 30 to dissipate heat.

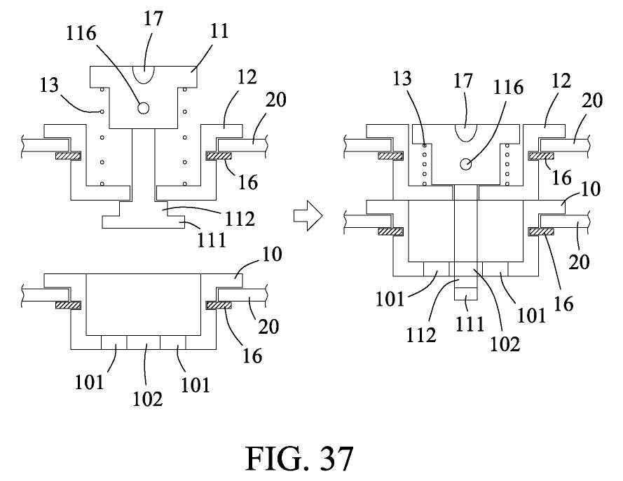

As shown in FIGS. 36 and 37, in addition to the foregoing embodiments, an embodiment of the present disclosure differs from the foregoing embodiments in that the fastening body 11 may enter the body 12, or the fastening part 11 is accommodated in the body 12. In this way, the present disclosure can better meet actual application requirements.

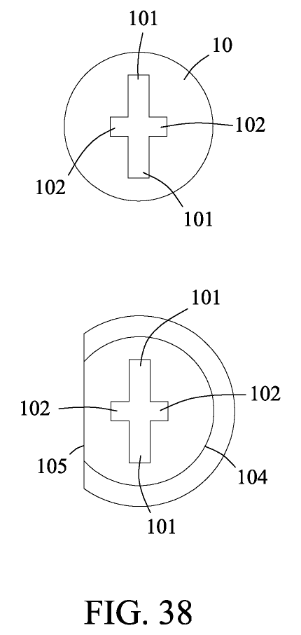

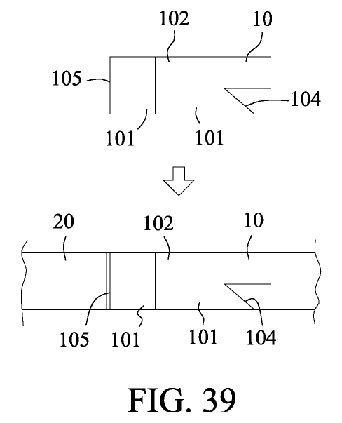

As shown in FIGS. 38 and 39, in addition to the foregoing embodiments, an embodiment of the present disclosure differs from the foregoing embodiments in that the fastened body 10 is provided with another connecting part 104, the another connecting part 104 is configured to rivet, expand, weld, lock, fasten, clamp, bind, or interfere with an object 20, or the fastened body 10 is provided with another anti-rotation part 105, and the anti-rotation part 105 is configured to prevent rotation with the object 20 to limit the fastened part 101 and the entering part 102 in a direction of the object 20. In this way, the present disclosure can better meet actual application requirements.

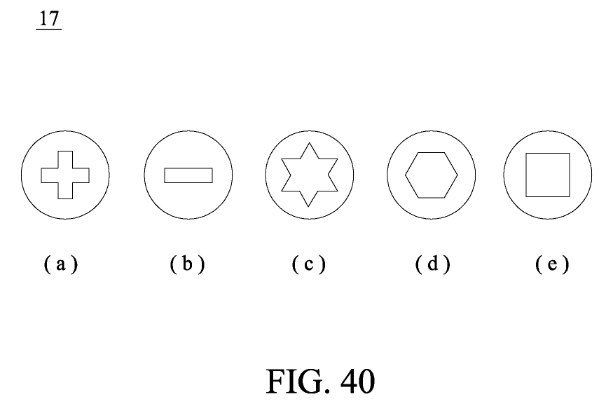

As shown in FIG. 40, in addition to the foregoing embodiments, in an embodiment of the present disclosure, the embodiment differs from the foregoing embodiments in that the operation part 17 may be cross-shaped (as shown in part a in FIG. 40), straight line-shaped (as shown in part b in FIG. 40), polyheon-shaped (as shown in part c in FIG. 40), or polygon-shaped (as shown in parts d and e in FIG. 40). Therefore, the operation part 17 of the present disclosure can better meet requirements of actual applications.

In conclusion, according to the fastening structure of the present disclosure, rapid combination and separation of at least two objects can be completed by means of cooperation of the first fastening part and the second fastening part of the fastening body, thereby achieving effects of repeated rapid combination and separation.

While the present disclosure has been described by means of specific embodiments, numerous modifications and variations could be made thereto by those skilled in the art without departing from the scope and spirit of the present disclosure set forth in the claims.

What is claimed is:

1. A fastening structure, comprising:
a fastening body, comprising a first fastening part and a second fastening part, configured to allow the fastening body to fasten into or fasten to a fastened part of a fastened body.

2. The fastening structure according to claim 1, wherein the first fastening part and the second fastening part pass through a passing part of an object and an entering part of the fastened body to rotate the fastening body, allowing the first fastening part to fasten into or fasten to the fastened part of the fastened body.

3. The fastening structure according to claim 1, wherein the first fastening part is configured to rotate after penetrating through or passing through an entering part of a fastened body, allowing the second fastening part to fasten to a fastened part of the fastened body.

4. The fastening structure according to claim 1, wherein the fastening body is rotated to allow the fastening body to fasten to the fastened body, and the fastening body is provided with an elastic component, or the elastic component presses against an object to apply a force for the fastening body to pop in, elastically fasten, rebound to fasten, or automatically and elastically retract to fasten to the fastened part, or the elastic component is a spring, a spring plate, a coil spring, an elastic cylinder, or an elastic disk, or the second fastening part elastically fastens, rebounds to fasten, or automatically and elastically retracts to fasten to the fastened part, or the first fastening part is configured to enter the fastened part to prevent rotation with the fastened part, or the fastening body is rotated to allow the fastening body to be fastened to the fastened body, the fastening body is provided with an elastic component or an intermediate body, or the elastic component presses against the intermediate body, and the intermediate body presses against the object, or the elastic component is a spring, a spring plate, an elastic cylinder, or an elastic disk, or the intermediate body is a sheet, a spring washer, an elastic component, an elastomer, a metal body, a plastic body, a non-metal body, a barrel, a cylinder, or a hollow body, or the elastic component is the intermediate body.

5. The fastening structure according to claim 1, wherein the second fastening part fastens or elastically fastens to the fastened part, or the first fastening part is configured to enter the fastened part to prevent rotation with the fastened part, or the first fastening part is smaller than the second fastening part, the fastened part is larger than the first fastening part and smaller than the second fastening part, and the fastened body has an entering part and the entering part is larger than the second fastening part.

6. The fastening structure according to claim 1, wherein the second fastening part fastens or elastically fastens to the fastened part, the first fastening part is configured to enter the fastened part to prevent rotation with the fastened part, the first fastening part is smaller than the second fastening part, the fastened part is larger than the first fastening part and smaller than the second fastening part, and the entering part is larger than the second fastening part.

7. The fastening structure according to claim 1, wherein the second fastening part fastens or elastically fastens to the fastened part, the first fastening part is configured to enter the fastened part to prevent rotation with the fastened part, the first fastening part is smaller than the second fastening part, and the fastened part is larger than the first fastening part and smaller than the second fastening part.

8. The fastening structure according to claim 1, wherein the fastening body is provided with an elastic component for pressing against an object, the second fastening part and the first fastening part pass through a passing part of the object and an entering part of the fastened body to rotate the fastening structure to allow, when the first fastening part reaches the fastened part of the fastened body, the first fastening part to automatically and elastically fasten, and elastically fasten into or rebound to fasten into the fastened part, or the first fastening part enters the fastened part to prevent rotation with the fastened part, or the second fastening part elastically fastens, rebounds to fasten, or automatically and elastically retracts to fasten to the fastened part.

9. The fastening structure according to claim 1, wherein the fastening body is provided with an elastic component for pressing against an object, the second fastening part and the first fastening part pass through a passing part of the object and an entering part of the fastened body to rotate the fastening structure to allow, when the second fastening part reaches a fastened part of the fastened boy, the second fastening part to automatically and elastically fasten, elastically fasten into, or rebound to fasten into the fastened part or automatically and elastically retract to fasten to the fastened part, or elastically fasten, elastically fasten into, or rebound to fasten into the fastened part or elastically retract to fasten to the fastened part.

10. The fastening structure according to claim 1, wherein the second fastening part and the first fastening part pass through a passing part of an object, or the passing part is a hole part, a circular hole, a slotted hole, an elliptical hole, an irregular-shaped hole, a quadrate hole, a square hole, a rectangular hole, a slot part, an elongated structure, a circular structure, or a structure corresponding to the entering part, or the fastening body has a rod part, wherein the rod part is smaller than the passing part, or the passing part is an anti-rotation part configured to prevent rotation with the first fastening part, the second fastening part, or the rod part, or the passing part is an anti-rotation part configured to prevent rotation with the first fastening part, the second fastening part, or the rod part, wherein the passing part is a hole part, a slotted hole, an elliptical hole, an irregular-shaped hole, a quadrate hole, a square hole, a rectangular hole, a slot part, or an elongated structure to prevent rotation.

11. The fastening structure according to claim 1, wherein the fastening body comprises two separately disposed fastening parts, or the fastening body is a fastening part disposed individually, or the second fastening part comprises two convex fastening bodies, or the second fastening part is a convex fastening body.

12. The fastening structure according to claim 1, wherein the fastening structure has a limiting body configured to connect the fastening body to an object, the limiting body is located between the object and the fastened body, or the fastening body has a limiting part configured to limit the limiting body, or the limiting body is a C-shaped fastener, a lateral fastening body, or a straight fastening body, or the limiting part is a concave part, a convex part, or a slot part.

13. The fastening structure according to claim 1, further comprising a body part, the fastening body being movably disposed on the body part, or the body part being provided with an elastic component, and two ends of the elastic component respectively pressing against the fastening body and the body part, wherein the second fastening part elastically fastens, elastically fastens into, or rebounds to fasten into the fastened part of the fastened body by means of an elastic force of the elastic component, or the first fastening part elastically and automatically retracts into the fastened part to prevent rotation with the fastened part.

14. The fastening structure according to claim 1, further comprising a body part, the fastening body being movably disposed on the body part, the body part being provided with a limiting part or a rotation space, or the fastening body further comprising a head part, or the head part being provided with an alignment part, or the alignment part being limited in the limiting part to move or being configured to allow the first fastening part to enter the entering part of the fastened body and allow the alignment part to rotate in the rotation space to allow the second fastening part to fasten to the fastened part, or the rotation space being a 360-degree full-perimeter structure, or the rotation space being a non-360-degree non-full-perimeter structure, or the rotation space being a full-perimeter structure of 30 degrees to 180 degrees, or the rotation space being a non-full-perimeter structure of 30 degrees to 270 degrees, or the rotation space being a convex body, a concave body, a planar body, a cambered body, a curved body, a barrier body, a hole body, a ring body, or a cross-sectional body.

15. The fastening structure according to claim 1, further comprising a body part, the fastening body being movably disposed on the body part, the body part being provided with a connecting part, or the connecting part being provided with an anti-rotation part, or the anti-rotation part being configured to prevent rotation with the object, limit a position, or limit a direction, or the anti-rotation part limiting a direction of the first fastening part or the second fastening part, or the anti-rotation part corresponding to the limiting part of the body part, the alignment part of the fastening body being configured to limit the direction of the first fastening part or the second fastening part, or the limiting part and the alignment part being convex bodies, concave bodies, planar bodies, cambered bodies, curved bodies, barrier bodies, hole bodies, ring bodies, or cross-sectional bodies.

16. The fastening structure according to claim 1, wherein the fastening body has an operation part configured to operate or configured to operate by using a tool, or has a restriction area higher than the operation part, the restriction area is configured to restrict transverse movement of the tool when the operation part is operated, or the restriction area is configured to restrict transverse movement of the tool from exceeding the restriction area when the operation part is operated, or the operation part is straight line-shaped, cross-shaped, flower-shaped, polygon-shaped, polyheon-shaped, a convex body, or a concave body, or the fastening body is movably connected to a body part, or the body part has a connecting part, or is configured to elastically connect or elastically fasten to the object.

17. The fastening structure according to claim 1, further comprising a body part, the fastening body being movably disposed on the body part, or the body part being provided with a connecting part, or the connecting part being configured to rivet, fasten, expand, weld, or lock to an object, or the connecting part being integrally formed on an object, or the connecting part having an elastic fastening part for elastically fasten and connect to the object.

18. The fastening structure according to claim 1, wherein the fastening body is rotated to allow the fastening body to fasten to the fastened body, the fastening body has a head part, the head part is combined with the fastening body by using a combination part, or the head part and the fastening body are integrally formed, or the fastening body has a head part, the head part is rotated to allow the second fastening part to fasten to the fastened part, or the first fastening part enters the fastened part to prevent rotation with the fastened part.

19. The fastening structure according to claim 1, wherein the fastening body is provided with a head part and a body part, the fastening body is movably disposed on the body part, the head part is rotated first to allow the second fastening part to be located at a fastening position corresponding to the fastened part, and then the head part is flipped or pulled to change a position of the head part on the body part to allow the second fastening part to fasten to the fastened part, or the first fastening part enters the fastened part to prevent rotation with the fastened part.

20. The fastening structure according to claim 1, wherein the fastening body is disposed on or connected to an object, or the object is a heat dissipation body, or a heating body is disposed between the object and the fastened body, or the fastening body cooperates with an elastic component to apply a pressing force to the radiator, or the radiator is configured to fit the heating body to dissipate heat, wherein the heating body is an Integrated Circuit (IC), a Central Processing Unit (CPU), a Graphic Processing Unit (GPU), a memory, a chip, or a battery, or the fastened body is a circuit board, a metal body, a plastic body, a fastening piece, or a fastening piece connected to another object, or the heating body is connected to the fastened body by means of welding, fastening, or using a connector, wherein the fastened body is an ironed part, a plastic part, a Printed Circuit Board (PCB), a radiator, an IC, a memory, a water-cooled component, a handle, a fan, a power supply, a fastener, a fastening piece, a connector, a case, a cabinet, a computer, an aircraft, a vehicle component, a robot, or a data center.

21. The fastening structure according to claim 1, further comprising a body part, the fastening body being movably disposed on the body part, the fastening body being provided with an alignment part, or the body part being provided with a limiting part and a rotation space, or the rotation space having a height stroke for activities and movement of the alignment part, or the limiting part having a height stroke for activities and movement of the alignment part, or a stroke of the second fastening part fastened to the fastened part being equal to or less than the height stroke of the rotation space, or a maximum stroke of the first fastening part penetrating through or passing through the fastened body being equal to or less than the height stroke of the limiting part and the height stroke of the rotation space, the fastening body and the body respectively have fastening parts, and the fastening parts are configured to fasten to each other and are configured to compress or stretch the fastened body or the object, or the fastening parts are internal tooth parts or external tooth parts.

22. The fastening structure according to claim 1, wherein the first fastening part or the second fastening part is a T-shape, a T-shape with steps, a T-shape with a protrusion, a T-shape with protrusions on two sides, an L-shape with a protrusion on one side, an approximate T-shape, an approximate L-shape, an approximate T-shape with a protrusion, an approximate L-shape with a protrusion, an approximate T-shape with protrusions on two sides, an approximate L-shape with protrusions on two sides, or an approximate T-shape with steps, or a combination of the first fastening part or the second fastening part is a T-shape, a T-shape with steps, a T-shape with a protrusion, a T-shape with protrusions on two sides, an L-shape with a protrusion on one side, an approximate T-shape, an approximate L-shape, an approximate T-shape with a protrusion, an approximate L-shape with a protrusion, an approximate T-shape with protrusions on two sides, an approximate L-shape with protrusions on two sides, or an approximate T-shape with steps, or the first fastening part is smaller than the second fastening part, the fastened part is larger than the first fastening part and is smaller than the second fastening part, and the entering part is larger than the second fastening part.

23. The fastening structure according to claim 1, wherein the fastening body further comprises a head part, the head part is configured for the combination part to connect the fastening body, and the head part is a rotating body and is configured to rotate and squeeze or apply a force to an elastic component to cooperate the second fastening part to compress or stretch the fastened body or the object, or is configured to compress or stretch the fastened body or the object, or the combination part is located and moves at a high position or a low position and is configured to rotate and squeeze or apply a force to the elastic component, or after the head part is rotated to change an angle, the combination part is located and moves at the high position or the low position, and is configured to rotate and squeeze or apply the force to the elastic component.

24. The fastening structure according to claim 1, wherein the fastening structure penetrates through the object to fasten to the fastened body, the object dissipates heat for a heating body, or the object is a heat dissipation body.

25. The fastening structure according to claim 1, further comprising a body, the fastening body being capable of entering the body, or the fastening body being accommodated in the body.

26. The fastening structure according to claim 1, wherein the fastened body is provided another connecting part, the another connecting part is configured to rivet, fasten, expand, weld, or lock to an object, or the connecting part being integrally formed on an object, or the connecting part having an elastic fastening part for elastically fasten and connect to the object.
